(19) United States
(12) Patent Application Publication
(10) Pub. No.: US 2005/0054454 A1
(43) Pub. Date: Mar. 10, 2005

(54) Configurable driveshaft assembly

(76) Inventor: Patrick L. Kurzeja, White Lake, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/659,551

(22) Filed: Sep. 10, 2003

(51) Int. Cl. F16C 3/00

(52) U.S. Cl. 464/179

(57) ABSTRACT

A driveshaft assembly includes a common male component and a female component in engagement with the male component. The female component includes a yoke, a configurable segment and a receptacle member. The configurable segment provides a length that corresponds to a desired vehicle driveshaft length.

### BACKGROUND OF THE INVENTION

The present invention relates generally to a vehicle drivetrain assembly and, more particularly, to a configurable driveshaft assembly.

Generally, the driveshaft operates within the drivetrain system to transmit torque from the engine to the axles and wheels. Engine torque is transmitted through a transmission to a forward driveshaft. The forward driveshaft transmits the torque through a forward axle and to the forward vehicle wheels. An interaxle driveshaft connects from the forward axle to the rear axle and transmits torque to the rear axle and to the rear vehicle wheels.

A driveshaft is typically assembled of two halves, a male half and a female half. When connected, the two halves form a driveshaft length for assembly into a particular vehicle configuration. Each vehicle typically requires a unique driveshaft assembly.

Conventional driveshafts utilize a tube on the male half in order to lengthen the driveshaft assembly. In this configuration the male half consists of a number of attached segments, one of the segments being the tube. By using a longer or shorter tube, the length of the assembly is made longer or shorter, respectively. Still, this type of tube assembly configuration may not adequately address the multiplicity of driveshaft configurations, particularly shorter lengths, as a minimal length is limited by the length of the female half. Therefore, numerous unique components are often required for each vehicle configuration.

Accordingly, it is desirable to provide for commonality of driveshaft components as well as improved capability in adapting a common driveshaft assembly to a particular vehicle driveshaft length.

### SUMMARY OF THE INVENTION

The driveshaft assembly of the present invention includes a common male component and a female component in engagement with the male component. The female component includes a yoke, a configurable segment, a positive stop member, a receptacle member, and a seal. The configurable segment has a predetermined length that corresponds to a particular vehicle driveshaft length. The present invention therefore provides for common driveshaft components among vehicles having different driveshaft assembly lengths by utilizing a different length configurable segment in each assembly.

The driveshaft assembly according to the present invention provides for commonality of driveshaft components as well as improved capability in adapting a common driveshaft assembly to a particular vehicle driveshaft length.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a schematic view of a drivetrain system;

FIG. 2 is a cross-sectional view of a driveshaft assembly according to the present invention;

FIG. 3 is a detailed view of a male component as illustrated in FIG. 2;

FIG. 4 is an exploded view of a female component as illustrated in FIG. 2; and

FIG. 5 is a cross-sectional view of another driveshaft assembly according to the invention.

### DETAILED DESCRIPTION OF THE PREFERRED EMBODIMENT

FIG. 1 refers to a vehicle drivetrain system 10 of a tandem axle configuration. Within the drivetrain system 10 there is an engine 12 that transmits power through a transmission 14 to a forward driveshaft assembly 16. The forward driveshaft assembly 16 transmits the engine power to a forward drive axle 18 which in turn drives the front tires 20. An interaxle driveshaft assembly 24 is coupled to the forward drive axle 18 and transmits engine power to a rear axle 26. The rear axle 26 in turn drives the rear tires 28.

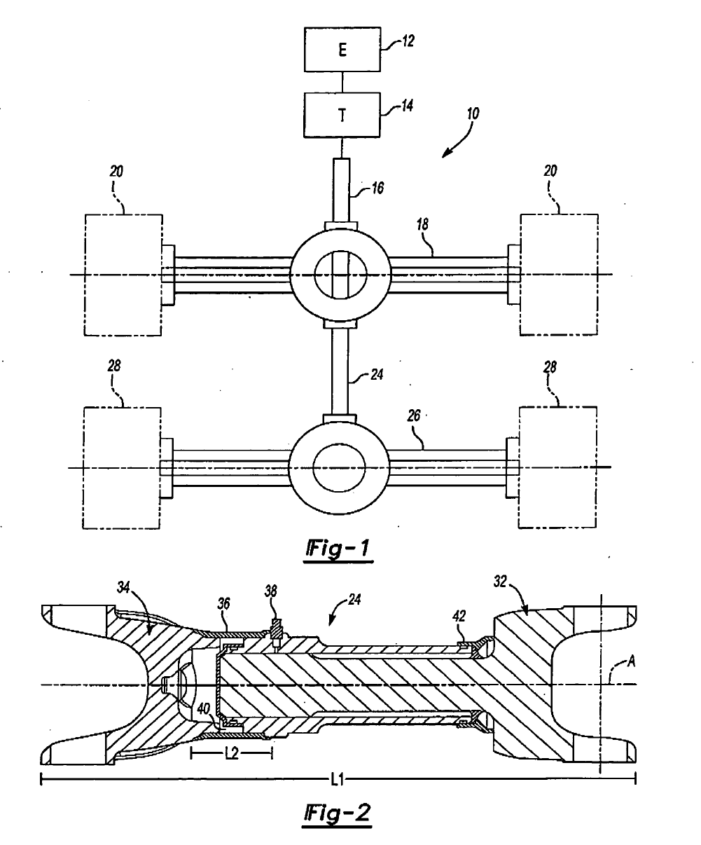

FIG. 2 illustrates a driveshaft assembly including a male component 32 and a female component 34. It should be understood that the term driveshaft as used herein includes the forward driveshaft, interaxle driveshaft, and other drivetrain components that likewise benefit from the invention. The female component 34 is in sliding engagement with the male component 32 along an axis 30. A grease fitting 38 and welch plug 40 are disposed in the female component 34. A seal 42 between the male component 32 and female component 34 prevents intrusion of foreign particles into the driveshaft assembly 24 and maintains lubrication for the sliding engagement between the male component 32 and female component 34.

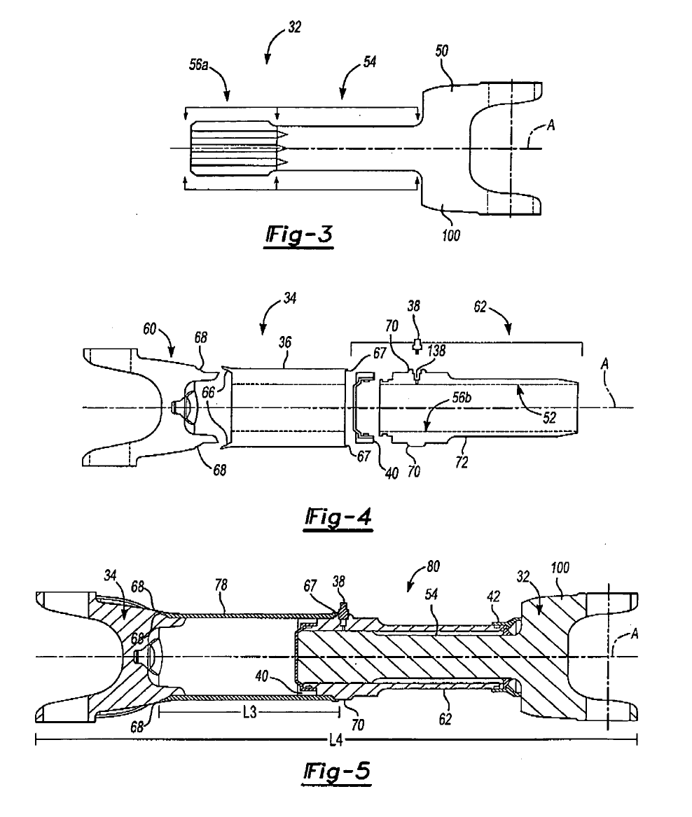

Referring to FIG. 3, the male component 30 includes a male yoke 50 which tapers into a stem portion 54. One segment of the stem portion 54 is a splined segment 56A which allows a sliding engagement with corresponding internal splines 56B (FIG. 4) within the female component 34.

Referring to FIG. 4, the female component 34 includes a female yoke 60 and a configurable segment 36. The configurable segment 36 is preferably tubular, however, other configurations will likewise benefit from the present invention. The configurable segment 36 comprises a rolled tube. The surrounding female components are preferably machined components. Alternatively, the configurable segment 36 may also comprise a machined component.

The configurable segment 36 has a beveled end portion 66 which engages female yoke beveled edge 68 and a second beveled edge 67 which engages a receptacle member 62.

Receptacle member 62 includes a welch plug 40 and a cylindrical member 72 which contains the internal splines 56B. The internal splines 56B provide sliding engagement with splined portion 56A (FIG. 3) of the male component 30. The female component 24 provides a grease aperture 68 to receive the grease fitting 38. A seal 77 prevents debris and the like from entering into the female component 34 as the male component 30 slides relative thereto.

Referring to FIG. 5, the driveshaft assembly 80 has a length L₄ that is longer than the driveshaft assembly 24 length L₁ (FIG. 2). Driveshaft assembly 80 includes a configurable segment 78 having a length L₃. Except for the configurable segment, the driveshaft assembly 80 utilizes the same components as the driveshaft assembly 24. The overall desired driveshaft length is therefore readily configurable with a minimum number of components.

The foregoing description is exemplary rather than definitive in nature. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

1. A configurable driveshaft assembly comprising:
a male component;
a female component in engagement with said male component, said female component comprising a configurable segment between a female yoke and a receptacle member, said configurable segment being selected from a plurality of optional different length configurable segments to result in a desired ovrall length for the configurable driveshaft assembly; and
a seal received at one end of said female component, and said male component having a yoke and a stem extending from said yoke into said female component, said seal sealing on an outer peripheral surface of said stem.

2. (Cancelled)

3. The configurable driveshaft assembly as recited in claim 1 wherein said configurable segment is tubular.

4. The configurable driveshaft assembly as recited in claim 1 wherein said configurable segment comprises a beveled edge.

5. The configurable driveshaft assembly as recited in claim 1 wherein said configurable segment is a rolled tube.

6. A drivetrain assembly comprising:
a first axle;
an interaxle driveshaft connected to said first axle, said interaxle driveshaft comprising a configurable segment between a female yoke and a receptacle member;
a second axle connected to said interaxle driveshaft, said configurable segment being selected from a plurality of optional different length configurable segments to result in a desired overall length for the interaxle driveshaft; and
a seal received at one end of said receptacle member, and a male component having a yoke and a stem extending from said yoke into said receptacle member, said seal sealing on an outer peripheral surface of said stem.

7. (Cancelled)

8. The drivetrain assembly as recited in claim 6 wherein said configurable segment is tubular.

9. The drivetrain assembly as recited in claim 6 wherein said configurable segment has at least one beveled edge.

10. The drivetrain assembly as recited in claim 6 wherein said configurable segment is a rolled tube.

11. A drivetrain assembly comprising:
a transmission;
a forward driveshaft connected to said transmission, said forward driveshaft comprising a configurable segment between a female yoke and a receptacle member;
an axle connected to said forward driveshaft, said configurable segment being selected from a plurality of optional different length configurable segments to result in a desired overall length for the forward driveshaft; and
a seal received at one end of said receptacle member, and a male component having a yoke and a stem extending from said yoke into said receptacle member, said seal sealing on an outer peripheral surface of said stem.

12. (Cancelled)

13. The drivetrain assembly as recited in claim 11 wherein said configurable segment is tubular.

14. The drivetrain assembly as recited in claim 11 wherein said configurable segment has at least one beveled edge.

15. The drivetrain assembly as recited in claim 11 wherein said configurable segment is a rolled tube.

16. The configurable driveshaft assembly as recited in claim 4, wherein said configurable segment has a beveled edge at each of two ends, a first of said beveled edges sitting on an outer peripheral surface of said female yoke, and a second of said beveled edges sitting on an outer peripheral surface of said receptacle member.

17. The drivetrain assembly as recited in claim 9, wherein said configurable segment has a beveled edge at each of two ends, a first or said beveled edges sitting on an outer peripheral surface of said female yoke, and a second of said beveled edges sitting on an outer peripheral surface of said receptacle member.

18. The drivetrain as recited in claim 14, wherein said configurable segment has a beveled edge at each of two ends, a first of said beveled edges sitting on an outer peripheral surface of said female yoke, and a second of said beveled edges sitting on an outer peripheral surface of said receptacle member.
